(19) United States
(12) Patent Application Publication
(10) Pub. No.: US 2002/0067710 A1
(43) Pub. Date: Jun. 6, 2002

(54) Method for managing bandwidth in a packet-based communication system

(75) Inventors: David P. Helm, Carol Stream, IL (US); John W. Maher, Woodstock, IL (US); Daniel J. McDonald, Cary, IL (US); Brian R. Poe, Cary, IL (US); Gerald Drobka, Palatine, IL (US)

Correspondence Address: MOTOROLA, INC., 1303 EAST ALGONQUIN ROAD, IL01/3RD, SCHAUMBURG, IL, 60196

(73) Assignee: Motorola, Inc.

(21) Appl. No.: 09/728,621

(22) Filed: Dec. 1, 2000

(51) Int. Cl. H04Q 7/28

(52) U.S. Cl. 370/338; 370/340

(57) ABSTRACT

A packet-based communication system and method of call control that allows variable numbers of calls of potentially multiple types (e.g., conventional and trunking calls) to proceed concurrently over shared links of an IP network without exceeding available bandwidth. Call counts are determined for one or more paths between endpoints, defining numbers of calls that are supportable by the one or more paths. The call counts may be apportioned between first and second types of call (e.g., between trunking and conventional calls). Upon receiving call requests that require use of one or more paths, the call requests are granted if they do not exceed the call counts associated with the one or more paths. Optionally, the call requests may be denied or busied if they exceed the call counts associated with the one or more paths. As another option, call requests of one type (e.g., trunking calls) may be granted even if there are no remaining call counts allocated for that type by borrowing call counts that are allocated for a second type (e.g., conventional calls) and/or by preempting calls of the second type.

### FIELD OF THE INVENTION

This invention relates generally to communication systems and, more particularly, to packet-based communication systems.

### BACKGROUND OF THE INVENTION

Communication systems typically include a plurality of communication units, such as mobile or portable radio units and dispatch consoles that are geographically distributed among various repeater sites and console sites. The communication units wirelessly communicate with the repeater sites and each other, and are often logically divided into various subgroups or talkgroups. Communication systems may be organized as trunked systems, where a plurality of communication resources is allocated amongst multiple users or groups by assigning the repeaters within a radio frequency (RF) coverage area on a call-bycall basis, or as conventional (non-trunked) radio systems where communication resources are dedicated to one or more users or groups. In trunked systems, or in mixed trunked and conventional systems, there is usually provided a central controller (sometimes called a “zone controller”) for allocating communication resources among multiple sites. The central controller may reside within a single device or multiple devices and may be located at a fixed equipment site or may be distributed among the repeater or console sites.

Traditionally, the repeater and console sites were linked via a circuit-switched architecture, through dedicated or on-demand circuits to a central radio system switching point (“central switch”). The circuits providing connectivity to the central switch required a dedicated wire for each endpoint (e.g., repeater site or console site) whether or not the endpoint was participating in a particular call. Often, the bandwidth (circuits) between endpoints were pre-provisioned for certain types of calls, for example for trunked calls and/or conventional calls. If a circuit was available for a trunking call, the zone controller reserved the circuit and granted the call. Otherwise, if a circuit was unavailable, the zone controller busied the call until such time as resources became available. For conventional calls, circuits were pre-allocated from the conventional channels to the central switch.

More recently, communication systems are using packet-switched networks where information that is to be communicated between endpoints is divided into packets and transported by various routers forming an Internet Protocol (IP) network. For example, communication systems using packet-switched networks are described and claimed in U.S. Pat. No. 6,141,347, titled “Wireless Communication System Incorporating Multicast Addressing and Method for Use” and U.S. patent application Ser. No. 09/464,269, titled “Methods for Implementing a Talkgroup Call in a Multicast IP Network,” each of which is assigned to the assignee of the present invention and incorporated herein by reference in its entirety. Packet-switched networks are sometimes called “connectionless” networks because they do not provide dedicated bandwidth or circuits between endpoints, but rather permit communications between multiple endpoints to proceed concurrently over shared paths or connections. Due to the “connectionless” nature of packet-based networks, it is possible for call controllers to over-subscribe certain links. The problem is exacerbated in shared trunking and conventional systems because trunking controller(s) and conventional server(s), either alone or in combination may establish more calls than the network can support.

Accordingly, there is a need for a method of call control in a packet-based communication system that provides for establishing calls over shared links of an IP network without exceeding available bandwidth. Advantageously, the method of call control will provide for managing bandwidth/call counts for different types of calls, including but not limited to trunking, conventional, telephony and data calls. The present invention is directed to satisfying these needs.

### BRIEF DESCRIPTION OF THE DRAWINGS

The foregoing and other advantages of the invention will become apparent upon reading the following detailed description and upon reference to the drawings in which:

FIG. 1 is a block diagram of a packet-based communication system according to the invention; and

FIG. 2 is a flowchart of a method of call control in a packet-based communication system according to the invention.

### DESCRIPTION OF PREFERRED EMBODIMENTS

The following describes a packet-based communication system and method of call control that enables variable numbers of calls of potentially different types to be established over shared links of an IP network without exceeding available bandwidth.

In one embodiment of the present invention, there is provided a method of call control in a communication system using a packet network for distributing packets between endpoints. The method comprises determining, for one or more paths between endpoints, a corresponding one or more call counts defining respective numbers of calls that are supportable by the one or more paths. The call counts may be apportioned between first and second types of call (e.g., between trunking and conventional calls). Upon receiving call requests that require use of one or more paths, the call requests are granted if they do not exceed the call counts associated with the one or more paths. Optionally, the call requests may be denied or busied if they exceed the call counts associated with the one or more paths or they may be granted by borrowing against call counts apportioned to a different type of call.

In another embodiment of the present invention, there is provided a method of call control in a mixed trunking and conventional communication system using a packet network for distributing packets between endpoints for varying numbers of calls. The method comprises determining, for at least one path between endpoints, a call count defining a number of calls that is supportable by the path, which call count is apportioned between a trunking allocation and a conventional allocation. Upon receiving call requests for trunking and conventional calls, the call requests are granted if they will result in a number of active trunking calls that does not exceed the trunking allocation and a number of active conventional calls that does not exceed the conventional allocation. Optionally, the call requests for trunking or conventional calls are denied or busied if they will result in a number of active trunking or conventional calls that exceed the respective trunking and conventional allocations. As another option, requests for trunking calls may be granted even if it will result in a number of active trunking calls that exceeds the trunking allocation, if there is sufficient available conventional allocation that may be borrowed to support the trunking call, or vice versa. As still another option, trunking calls may be granted if they will result in a number of active trunking calls that exceeds the trunking allocation and if there is, at a time of the call request, insufficient available conventional allocation that may be borrowed to support the trunking call, by pre-empting one or more active conventional calls as needed to sufficiently increase the available conventional allocation to an amount that may be borrowed to support the trunking call, or vice versa.

In still another embodiment of the present invention, there is provided a communication system using a packet network for distributing packets between endpoints. A controller determines, for at least one path between endpoints, a call count defining a number of calls that is supportable by the path. The call count may be apportioned between different types of calls (e.g., trunking, conventional, telephony and/or data calls). The path(s) may include, for example, trunking or conventional repeater site links, console site links or links between different communication zones. The controller grants, denies or busies call requests, possibly of the different types without exceeding the call count(s) associated with the path(s).

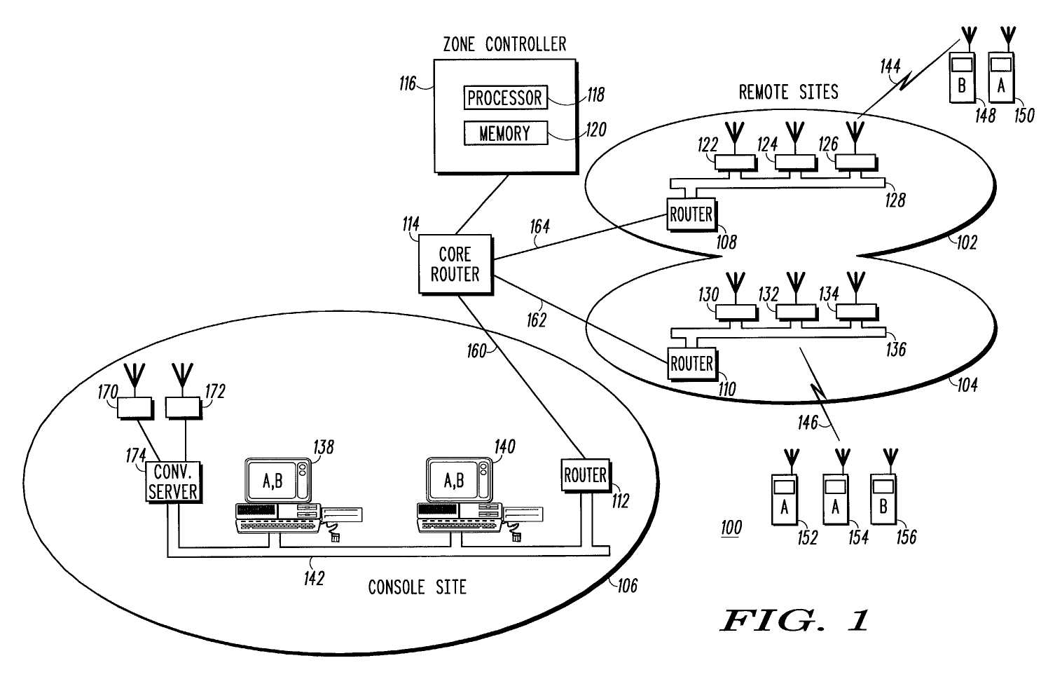

Turning now to the drawings and referring initially to FIG. 1, there is shown a packet-based communication system (or “network”) 100 comprising a plurality of sites 102, 104, 106 that are logically coupled, via respective router elements 108, 110, 112 to a core router element 114. The router elements 108-114 may be embodied in separate physical devices, for example, 3Com “NetBuilder” series routers, or combinations of such devices. For convenience, the router elements will hereinafter be referred to as “routers.” The core router 114 is coupled to a zone controller 116 having a processor 118 (such as a microprocessor, microcontroller, digital signal processor or combination of such devices) and a memory 120 (such as volatile or non-volatile digital storage devices or combination of such devices). In one embodiment of the present invention, the zone controller 116 manages and assigns infrastructure bandwidth (or “call units”) between endpoints of the communication system for routing payload (voice, data, video, etc.) and/or control messages that are to distributed between and among the various sites 102, 104, 106.

As shown, the communication system 100 is a mixed trunking and conventional system. Site 102 includes a plurality of repeaters 122, 124, 126 (“trunking repeaters”) that are assigned on a call-by-call basis to communication units 148, 150 within the radio frequency (RF) coverage area of site 102. Site 104 similarly includes a plurality of trunking repeaters 130, 132, 134 that are assigned on a call-by-call basis to communication units 152, 154, 156 within the coverage area of site 104. Site 106 includes a plurality of conventional repeaters 170, 172 that wirelessly communicate with communication units (not shown) in their coverage area via dedicated RF channels. The conventional repeaters 170, 172 are linked to the console site 106 by a conventional server 174.

The communication units 148-156 (sometimes called “subscriber units”) may comprise mobile or portable wireless radio units and may be arranged into talk groups having corresponding talk group identifications as known in the art. Any number of talk groups having corresponding talk group identifications can be established within the system 100. In FIG. 1, for example, two separate talk groups are shown, identified by labels “A” and “B.” Talk group “A” at least includes the communication units 150, 152, 154 and talk group “B” at least includes the communication units 148, 156. The communication system 100 may also support point-to-point calls, for example, between communication units 148 and 152.

Generally, the repeaters at sites 102, 104 communicate, via wireless communication resources 144, 146 with the communication units 148-156. Suitable wireless communication resources 144, 146 are multiple RF (radio frequency) channels such as pairs of frequency carriers, time division multiple access (TDMA) slots, code division multiple access (CDMA) channels, or any other RF transmission media. In the case where the communication resources comprise RF channels, it is common to assign separate channels and/or separate repeaters for different types of communication traffic. Thus, the repeaters at the various sites 102, 104 may comprise control channel repeaters, voice channel repeaters and/or link repeaters. For convenience, the term “repeater site” or simply “base site” will be used hereinafter instead of referring specifically to the repeater(s) at a particular site. The repeaters 122, 124, 126 are coupled, via Ethernet 128 to an associated router 108 and the repeaters 130, 132, 134 are coupled, via Ethernet 136 to router 110.

Site 106 includes a plurality of dispatch consoles 138, 140 that are coupled via Ethernet 142 to router 112 and defines a “console” site. Consoles 138, 140 may comprise wireless or wireline consoles. Console positions 138, 140 can affiliate with either, or both talkgroups “A” and “B” and, accordingly, may be considered members of both talk groups “A” and “B.” In the illustrated embodiment, the console site includes a conventional server 174 connected to conventional repeaters 170, 172. As will be appreciated, conventional repeaters may be located at the repeater sites 102, 104 instead of or in addition to the console site 106. Of course, conventional repeaters may be eliminated entirely to define a pure trunking system. Moreover, it will be appreciated that a repeater site may include console positions, and vice versa.

Practitioners skilled in the art will appreciate that the network 100 may include various other communication devices not shown in FIG. 1. For example, the network 100 may include wireline communication device(s), site controller(s), comparator(s), telephone interconnect device(s), internet protocol telephony device(s), call logger(s), scanner(s) and gateway(s). Generally, such communication devices may be either sources or recipients of payload and/or control messages routed through the network 100. These devices are described briefly below.

A site controller is a device having a processor (such as a microprocessor, microcontroller, digital signal processor or combination of such devices) and a memory (such as volatile or non-volatile digital storage devices or combination of such devices), that may be located at a particular site. A site controller may be used to control the communication of payload and/or control messages between repeater(s) at a particular site. A site controller may also control communications between the repeater(s) and their associated router. In one embodiment, for example, a site controller sends IGMP Leave and Join messages to a router associated with a particular site to enable the repeater(s) at that site to receive payload and/or control messages addressed to particular multicast group address(es).

A comparator (or “voter”) is a device, usually connected by wireline to various receivers (e.g., different repeaters) receiving different instance(s) of a particular message or signal (e.g., from a subscriber radio unit). The comparator receives and compares among the different instances of the signal that may be received by the different receivers, and produces an output message that is comprised of either an entire message from one of the receivers or a composite message comprised of segments of the message received from one or more of the receivers. Each message may be comprised of a plurality of message frames.

A scanner is a receiver that is adapted to monitor message transmissions from communication devices such as mobile or portable wireless radio units, consoles, repeaters, and the like. In one mode of operation, for example, a scanner scans the radio spectrum for the purpose of finding and, optionally, locking on to carrier frequencies containing message transmissions. Scanners are sometimes used by parties that are not intended recipients of the message transmissions and thus may or may not be members of a particular talkgroup for which the message transmissions are intended.

A telephone interconnect device is a network-based device that provides voice transcoding services between mobile and land line subscribers when invoking fall duplex telephone calls between those two subscribers. A transcoding service is required, for example, when a mobile subscriber using ACELP vocoding requests a call to a subscriber in the public switched telephone network (PSTN) using 64-kilobit per second PCM vocoding.

An internet protocol telephony device comprises a telephone that transports voice and/or control messages over a LAN to a telephony gateway box, which interfaces multiple (LAN based) phones and converts the IP control and audio packets back into the format of the local PSTN. More generally, a gateway device is one that provides voice and control translation services between two dissimilar communication systems. For example, a gateway device would be required if an APCO Project 25 compliant system were to be connected to a GSM system. Other services such as feature translation, authentication, authorization and encryption could also be provided by a gateway device.

A call logger is a networked based device that records packetized voice talkgroup and private calls in a public safety system. A call logger could also record data calls. A call logger device typically stores the voice payload in its native format (i.e. vocoded audio). When it is desirable to playback the voice conversation at a later time, the call logger retrieves and decodes all packets which bound the call in question.

In one embodiment, the repeaters 122, 124, 126 and router 108 at site 102, the repeaters 130, 132, 134 and router 110 at site 104, the repeaters 170, 172, conventional server 174, consoles 138, 140 and router 112 at site 106, the core router 114 and zone controller 116 are all IP host devices that are able to send and receive IP datagrams between other host devices of the network. Each host device has a unique IP address. The host devices include respective processors (which may comprise, for example, microprocessors, microcontrollers, digital signal processors or combination of such devices) and memory (which may comprise, for example, volatile or non-volatile digital storage devices or combination of such devices). The routers 108-114 are specialized or general purpose computing devices configured to receive IP packets or datagrams from a particular host in the communication system 100 and relay the packets to another router or another host in the communication system 100.

As will be appreciated, any IP host device including, but not limited to, repeater/base station(s), console(s), router(s), site controller(s), comparator/voter(s), scanner(s), site controller(s), telephone interconnect device(s) or internet protocol telephony device(s) may be a source or recipient of IP packets. The routers 108-114 respond to addressing information in the IP packets received to properly route the packets to their intended destination. In accordance with internet protocol, the IP packets may be designated for unicast or multicast communication. Unicast is communication between a single sender and a single receiver over the network. Multicast is communication between a single sender and multiple receivers on a network. Each type of data communication is controlled and indicated by the addressing information included in the packets of data transmitted in the communication system 100. For a unicast message, the address of the packet indicates a single receiver. For a multicast communication, the address of the packet indicates a multicast group address to which multiple hosts may join to receive the multicast communication. In such case, the routers of the network replicate the packets, as necessary, and route the packets to the designated hosts via the multicast group address.

For example, a typical multicast communication begins with a sourcing host (e.g., repeater 126) receiving a call request from a communication unit 150. For purposes of the present example, assume that the call request is for a talk group call (“talk group A”). The repeater 126 forwards the call request to the zone controller 116 and, based on mobility and talk group affiliations of the communication units, the zone controller 116 determines which endpoints need to participate in the call. Thus, for talk group A, the zone controller might determine that repeater 126 at site 102, repeater 132 at site 104 and consoles 138, 140 at site 106 are the endpoints for the call. The zone controller 116 forwards a multicast group address to those endpoints, via the core router 114 and local routers 108, 110, 112. The endpoints send Internet Group Management Protocol (IGMP) Join messages to their respective local routers, which are forwarded to the core router 114 to form a spanning tree of router interfaces logically connecting the participating hosts. In the present example for talk group A, the spanning tree of router interfaces would include links 160, 162, 164 between the local routers and the core router. The sourcing host sends payload (e.g., audio, video, etc.) from the communication unit on the multicast group address, which payload then may be received by participating hosts having successfully joined the multicast group address.

Additionally, the conventional server 174 may grant conventional calls, concurrently with the trunking calls, that require use of the shared links 160, 162 or 164. Heretofore, it has possible for the zone controller 116 and conventional server 174, either alone or in combination, to grant more calls than the network can support. Although any of the shared links are susceptible for oversubscription, repeater site links (e.g., links 160, 162) are historically not a concern because they are sized to accommodate worst case loading scenarios. That is not the case, however, for console site links (e.g., link 160) and inter-zone links (e.g., between core routers in different zones, not shown in FIG. 1) because, for practical reasons, they are not sized to accommodate worst case loading scenarios. As an example, Motorola's SMARTZONE™ communication systems may include consoles sites with up to 30 consoles each accommodating up to 64 calls. In such case, it is economically impractical to size the console site link to accommodate 1,920 (i.e., 64×30) calls. Rather, the link is sized to accommodate a number of calls that is reasonable, within the budget constraints of the system. For purposes of illustration, suppose a console site link (e.g., link 160) is sized to accommodate 100 call units of bandwidth. In such case, it is possible for trunking calls granted by the zone controller 116 alone, for conventional calls granted by the conventional server 174 alone, or for a combination of trunking and conventional calls granted by the zone controller 116 and conventional server 174, respectively, to use greater than 100 call units of bandwidth at any given time on the console site link 160.

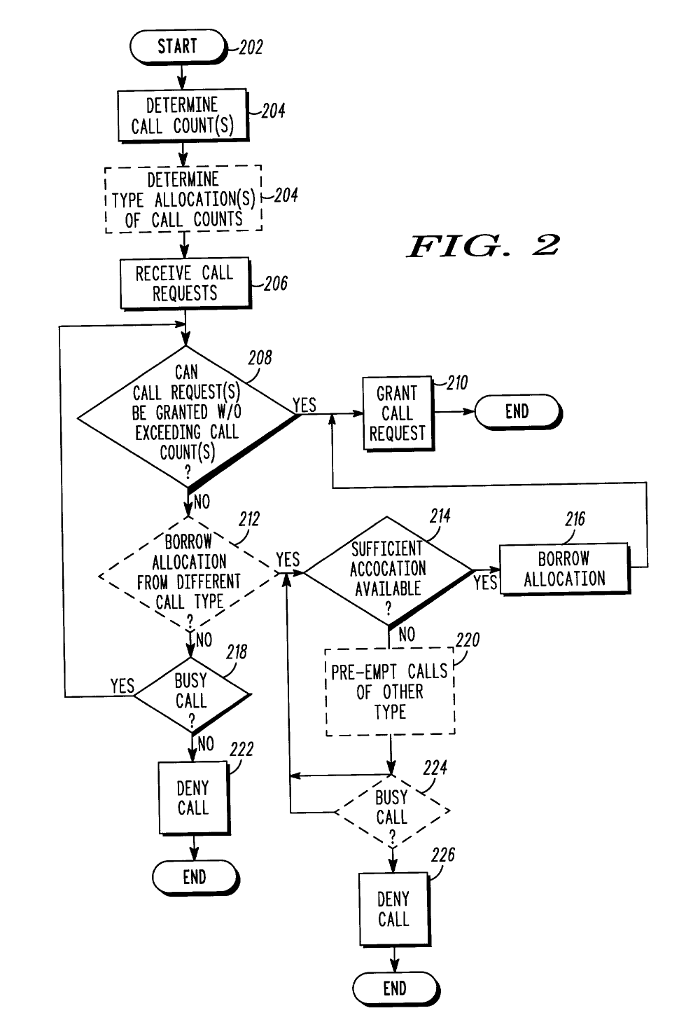

FIG. 2 is a flowchart illustrating a method of call control that allows for establishing calls over shared links of an IP network without exceeding available bandwidth. At step 202, call count(s) (e.g., call units of bandwidth) are determined for one or more paths between endpoints of a communication system. The one or more paths comprise virtual connections between endpoints, through the packet network. In one embodiment, the call counts are pre-configured by the system user/operator or zone controller according to the number of call units that are supportable over the different links. The call count(s) are stored in the memory 120 of the zone controller 116 and may be changed, as needed, as system parameters change. In one embodiment, the zone controller periodically requests from the routers of the packet network, a currently supportable number of calls for each respective path and reduces or adds to call counts accordingly. For example, call counts may be reduced dynamically in the event of link failures or outages in the system.

In one embodiment, call counts are determined for console site links or inter-zone links, because those links have the most need for call control. However, as will be appreciated, call counts may be determined for links to any fixed equipment site(s), including repeater site links. For convenience, an example call count of 100 units of bandwidth is presumed to be established for the link 160 between the core router 114 and the console site router 112. That is, at step 202, for purposes of the present example, it has been determined that 100 units of bandwidth are supportable by the link 160, which call units may be used by a variety of different types of calls.

Optionally, at step 204, portions of the call count(s) may be allocated for different types of calls. In one embodiment, for example, a trunking allocation is reserved for trunking calls and a conventional allocation is reserved for conventional calls in a mixed trunking and conventional system. Alternatively or additionally, allocations may be determined for telephony, data or generally any other type of calls. The allocations may be determined in any manner, for example, by designating numbers or percentages of the call count for the different types of calls. In one embodiment, the sum of the allocations for different types of calls does not exceed the call count(s) for any link. Thus, for example, if the call count of 100 call units of bandwidth for link 160 is to be apportioned between trunking and conventional calls, 70 call units might be reserved for trunking calls and 30 call units reserved for conventional calls.

At step 206, the zone controller 116 receives call request(s) that require use of one or more paths. The requests may possibly be for different types of calls (e.g., trunking, conventional, telephony and/or data calls). In one embodiment, the conventional server will request call bandwidth to specific sites from the zone controller 116 whenever it wants to establish a conventional call. For each request, at step 208, the zone controller 116 determines every inter-zone and/or console link(s) in the path and determines if the call request can be granted without exceeding the call count(s) (or, if applicable, without exceeding the appropriate type allocation) associated with those links. If so, the zone controller 116 grants the call request at step 210. Thus, continuing the present example with respect to the console site link 160, the zone controller will grant call requests for trunking calls if granting the request will result in no greater than 70 call units of bandwidth being used for active trunking calls, and similarly will grant call requests for conventional calls if granting the request will result in no greater than 30 call units of bandwidth being used for active conventional calls. For paths requiring inter-zone links, with links in different communication zones, the zone controllers in each respective zone communicate amongst themselves to establish the necessary call count(s).

Optionally, at step 212, in the case where the call count is divided into allocations for different types of calls (e.g., trunking and conventional calls), and where the call request is for a certain type of call that can not be granted without exceeding its associated type allocation, the zone controller may “borrow” allocation(s) from different types of calls. Thus, continuing the present example, if the zone controller receives a request for a trunking call that, if granted, would result in active trunking calls using greater than 70 call units of bandwidth, it may be desirable to borrow call units reserved for conventional calls. If it is not desired to borrow call units reserved for the other type, the call may be busied at step 218 until such time as there are available call units that will support the call, or the call request may be denied at step 222.

Conversely, if it is desired to borrow call units reserved for another type call, the zone controller determines at step 214 if there is sufficient allocation of call units of the other type available that would support the call request. If so, the zone controller borrows the allocation at step 216 and proceeds to grant the call request at step 210. Thus, in the present example, if 30 call units of bandwidth are reserved for conventional calls and 20 are being used at the time of the trunking call request, 10 call units of the conventional allocation are eligible to be borrowed for the trunking call. If that is sufficient to support the trunking call, the zone controller may grant the trunking call and, for the duration of the trunking call, reduce the conventional allocation. Conversely, as will be appreciated, portions of the trunking allocation might also be borrowed to support conventional call requests.

As another option, at step 220, if it is desired to borrow call units from another type but there is not enough available call units of the other type that would support the call, the zone controller may pre-empt active calls of the other type as needed to sufficiently increase the available allocation to an amount that may be borrowed to support the call request. For example, upon receiving a request for a trunking call, where granting the call request would result in exceeding the trunking allocation and where the available conventional allocation is not enough to support the call, one or more active conventional calls may be preempted until such time as there is enough available conventional allocation that may be borrowed to support the call. At step 214, once there is sufficient available allocation of the other type, the allocation is borrowed at step 216 and the call request is granted at step 210.

As still another option, if it is desired to borrow call units from another type but there is not enough available call units of the other type that would support the call, and it is not desired to pre-empt active calls of the other type, the call may be busied at step 224 until such time as there are available call units of either type that will support the call, or the call request may be denied at step 226.

The present disclosure therefore has identified a method of call control in a packet-based communication system that allows for establishing different types of calls, including but not limited to trunking and/or conventional calls over shared links of an IP network without exceeding available bandwidth. The method allows for service interaction between trunking and conventional calls, such that calls from one service may be busied or preempted, as appropriate, to ensure adequate bandwidth availability for the other service.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. In a communication system using a packet network for distributing packets between endpoints for varying numbers of calls, a method comprising:
determining, for one or more paths between endpoints, a corresponding one or more call counts defining respective numbers of calls that are supportable by the one or more paths;
receiving a call request that requires use of one or more paths;
granting the call request if it does not exceed the call counts associated with the one or more paths.

2. The method of claim 1, wherein the step of receiving a call request comprises receiving a call request of the type selected from the group consisting of: trunking calls, conventional calls, telephony and data calls.

3. The method of claim 1, wherein the step of determining one or more call counts comprises identifying, for each respective path, a pre-designated number of calls supportable by the path.

4. The method of claim 1, wherein the step of determining one or more call counts comprises requesting, from the packet network, a currently supportable number of calls for each respective path.

5. The method of claim 1, comprising:
determining, for at least one of the call counts, a first allocation reserved for a first type of call and a second allocation reserved for a second type of call;
receiving call requests for either of the first and second types of calls;
granting the call requests if they will result in a number of active calls of the first and second types that does not exceed the respective first and second allocations.

6. The method of claim 5, comprising:
rejecting a call request if, at a time of the request, it would result in a number of active calls of either the first and second types that exceeds the respective first and second allocations.

7. The method of claim 5, further comprising:
busying a call request, yielding a busied call request if, at a time of the request, it would result in a number of active calls of either the first and second types that exceeds the respective first and second allocations; and
granting the busied call request at a later time if, at the later time, it will result in a number of active calls of the first and second types that does not exceed the respective first and second allocations.

8. In a mixed trunking and conventional communication system using a packet network for distributing packets between endpoints for varying numbers of trunking and conventional calls, a method comprising:
determining, for at least one path between endpoints, a call count defining a number of calls that is supportable by the path;
determining a trunking allocation of the call count;
determining a conventional allocation of the call count; and
upon receiving call requests for trunking and conventional calls, granting the call requests if they will result in a number of active trunking calls that does not exceed the trunking allocation and a number of active conventional calls that does not exceed the conventional allocation.

9. The method of claim 8, comprising:
upon receiving a request for a conventional call, rejecting the call request if, at a time of the request, it would result in a number of active conventional calls that exceeds the conventional allocation.

10. The method of claim 8, further comprising:
upon receiving a request for a conventional call, busying the call request, yielding a busied call request if, at a time of the request it would result in a number of active conventional calls that exceeds the conventional allocation; and
granting the busied call request at a later time if, at the later time it would result in a number of active conventional calls that does not exceed the conventional allocation.

11. The method of claim 8, comprising:
upon receiving a call request for a trunking call, granting the call request even if it will result in a number of active trunking calls that exceeds the trunking allocation, if there is sufficient available conventional allocation that may be borrowed to support the trunking call.

12. The method of claim 8, comprising:
upon receiving a call request for a trunking call, granting the call request even if it will result in a number of active trunking calls that exceeds the trunking allocation and if there is, at a time of the call request, insufficient available conventional allocation that may be borrowed to support the trunking call, by pre-empting one or more active conventional calls as needed to sufficiently increase the available conventional allocation to an amount that may be borrowed to support the trunking call.

13. The method of claim 8, comprising:
upon receiving a call request for a conventional call, granting the call request even if it will result in a number of active conventional calls that exceeds the conventional allocation, if there is sufficient available trunking allocation that may be borrowed to support the conventional call.

14. The method of claim 8, comprising:
upon receiving a call request for a conventional call, granting the call request even if it will result in a number of active conventional calls that exceeds the conventional allocation and if there is, at a time of the call request, insufficient available trunking allocation that may be borrowed to support the conventional call, by preempting one or more active trunking calls as needed to sufficiently increase the available trunking allocation to an amount that may be borrowed to support the conventional call.

15. A communication system comprising:
a packet network for distributing packets between endpoints;
a controller for determining, for at least one path between endpoints, a call count defining a number of calls that is supportable by the path, the call count being apportioned between at least a first and second type of call; and
means for granting call requests of the first and second types of call without exceeding the call count.

16. The communication system of claim 15 wherein the at least one path comprises a virtual connection between endpoints, through the packet network.

17. The communication system of claim 15 having one or more repeater sites, the at least one path comprising a repeater site link.

18. The communication system of claim 17, wherein the repeater site link comprises a link from a core router to a local router associated with a trunking repeater site.

19. The communication system of claim 17, wherein the repeater site link comprises a link from a core router to a local router associated with a conventional repeater site.

20. The communication system of claim 15 having one or more console sites, the at least one path comprising a console site link.

21. The communication system of claim 20, wherein the console site link comprises a link from a core router to a local router associated with a console site.

22. The communication system of claim 15 comprising a plurality of communication zones each having an associated controller, the at least one path comprising an inter-zone link between controllers.

23. The communication system of claim 15, wherein the call count is apportioned between trunking and conventional calls.
